(19) United States
(12) Patent Application Publication
(10) Pub. No.: US 2018/0045215 A1
(43) Pub. Date: Feb. 15, 2018

(54) IMPELLER FOR ROTARY MACHINE, COMPRESSOR, SUPERCHARGER, AND METHOD FOR PRODUCING IMPELLER FOR ROTARY MACHINE

(71) Applicant: MITSUBISHI HEAVY INDUSTRIES, LTD., Tokyo (JP)

(72) Inventors: Takashi ARAI, Tokyo (JP); Daigo WATANABE, Tokyo (JP); Wataru MURONO, Tokyo (JP); Hideki YAMAGUCHI, Tokyo (JP); Taiji TORIGOE, Tokyo (JP); Aki INOUE, Tokyo (JP); Yuya KONNO, Tokyo (JP)

(73) Assignee: MITSUBISHI HEAVY INDUSTRIES, LTD., Tokyo (JP)

(21) Appl. No.: 15/546,453

(22) PCT Filed: Mar. 25, 2015
(86) PCT No.: PCT/JP2015/059092

§ 371 Date: Jul. 26, 2017

(51) Int. Cl. F04D 29/28; C23C 18/16; C23C 18/50; F02M 26/06; F04D 29/02

(52) U.S. Cl. CPC F04D 29/284; F02M 26/06; F04D 29/023; C23C 18/50; C23C 18/1637; F02B 37/00

(57) ABSTRACT

An impeller for a rotary machine includes: a base material of the impeller comprising Al or an Al alloy; and an electroless plating layer disposed so as to cover the base material, the electroless plating layer forming a surface layer of the impeller. The electroless plating layer comprises a Ni—P based alloy having an amorphous structure, the Ni—P based alloy having a P content rate of not less than 5 wt % and not more than 11 wt % in the electroless plating layer.

### TECHNICAL FIELD

The present disclosure relates to an impeller for a rotary machine, a compressor provided with the impeller, a supercharger, and a method for producing the impeller.

### BACKGROUND ART

An internal combustion engine for an automobile, a diesel engine in particular, is often provided with an exhaust gas recirculation (EGR) system. A part of exhaust gas is introduced into a compressor for a supercharger mounted to an internal combustion engine provided with an EGR system, and thus erosion is likely to occur in the compressor impeller due to droplets contained in the exhaust gas. Thus, as a countermeasure against erosion, Ni—P based plating is applied to a compressor impeller made of an Al alloy or the like.

Further, a stress due to a centrifugal force generated from high-speed rotation and a stress due to a thermal expansion difference between a Ni—P based plating layer and an Al alloy are generated in a compressor impeller of a supercharger. Thus, a plating layer is required to have not only an anti-erosion property but also an anti-crack property (fatigue strength) and an anti-separation property (interface strength).

Once a crack develops on a plating layer, the crack advances to a base material and may break the base material.

Patent Document 1 discloses applying Ni—P based alloy plating to a compressor impeller of a supercharger mounted to a ship diesel engine equipped with an EGR system, to improve an anti-erosion property and an anti-corrosion property.

### CITATION LIST

### Patent Literature

Patent Document 1: JP2014-163345A

### SUMMARY

### Problems to be Solved

While the thickness of a plating layer could be increased to improve the anti-erosion property of the plating layer, a plating layer with an excessively-increased thickness is more likely to separate from the interface of a base material and has a greater risk of generation of fatigue cracks on the surface of the plating layer. On the other hand, a coating layer with a reduced thickness is less likely to develop fatigue cracks, but the anti-erosion property may decrease.

As described above, the anti-erosion property and the anti-crack property are incompatible, and it is difficult to balance these two properties.

In view of the above problem of typical art, at least one embodiment of the present invention is to enable forming a plating layer that has an anti-erosion property and an anti-crack property (fatigue strength) in a good balance, for an impeller for a rotary machine.

### Solution to the Problems

(1) An impeller for a rotary machine according to at least one embodiment of the present invention comprises: a base material of the impeller comprising Al or an Al alloy; and an electroless plating layer disposed so as to cover the base material, the electroless plating layer forming a surface layer of the impeller. The electroless plating layer comprises a Ni—P based alloy having an amorphous structure, the Ni—P based alloy having a P content rate of not less than 5 wt % and not more than 11 wt % in the electroless plating layer.

With the above configuration (1), the electroless plating layer has an amorphous structure and thus has a high strength and an improved anti-erosion property. Furthermore, the electroless plating layer contains P of not less than 5 wt % and not more than 11 wt %, thus having a high Vickers hardness and an excellent anti-crack property (fatigue strength), which makes it possible to suppress generation of cracks on the impeller.

Moreover, the electroless plating layer can be formed uniformly, for instance, in terms of the layer thickness, and thus it is possible to exert the above properties uniformly over a broad range.

(2) In some embodiments, in the above configuration (1), the electroless plating layer has a layer thickness of not less than 15 μm and not more than 60 μm.

If the layer thickness of the electroless plating layer is less than 15 μm, it may be difficult to exert the anti-erosion property and the anti-crack property sufficiently. On the other hand, even if the layer thickness is increased to exceed 60 μm, the effect to improve the anti-erosion property and the anti-crack property is limited, which increases the plating time and costs.

With the above configuration (9), it is possible to achieve the anti-erosion property and the anti-crack property with the electroless plating layer having a layer thickness of not less than 15 μm, and it is possible to reduce the plating costs with the electroless plating layer having a layer thickness of not more than 60 μm.

(3) In some embodiments, in the above configuration (1) or (2), the electroless plating layer has a Vickers hardness of not less than 500 HV and not more than 700 HV.

With the above configuration (3), the electroless plating layer has a Vickers hardness of not less than 500HV and thus can exert an anti-erosion property, while having a Vickers hardness of not more than 700HV and thus being able to exert a high anti-crack property.

(4) In some embodiments, in any one of the above configurations (1) to (3), a fracture ductility strain of the electroless plating layer is not less than 0.5% (not repeated but once).

With the above configuration (4), if the fracture property strain is not less than 0.5%, it is possible to form a plating layer having a high anti-fatigue fracture property, and thus it is possible to satisfy the allowable repetitive number in a low-cycle fatigue test. Accordingly, it is possible to suppress generation of cracks of an impeller and improve the lifetime of an impeller.

(5) In some embodiments, in any one of the above configurations (1) to (4), the impeller is a compressor impeller of a supercharger.

With the above configuration (5), the compressor impeller having the above configuration is used as the compressor impeller of the supercharger that rotates at a high speed, and thereby it is possible to improve the anti-erosion property and the anti-crack property (fatigue strength) of the compressor impeller. Accordingly, it is possible to achieve a long-life compressor impeller.

(6) A compressor according to at least one embodiment of the present invention comprises a compressor impeller which comprises the impeller according to any one of the above (1) to (5).

With the above configuration (6), providing a compressor impeller with a high anti-erosion property and anti-crack property (fatigue strength) makes it possible to extend the lifetime of the compressor.

(7) A supercharger according to at least one embodiment of the present invention comprises: the compressor according to the above (6); and a turbine for driving the compressor.

With the above configuration (7), providing a compressor including a compressor impeller with a high anti-erosion property and anti-crack property (fatigue strength) makes it possible to achieve a long-life supercharger that can bear high-speed rotation for a long period of time.

(8) In some embodiments, in the above configuration (7), the compressor is disposed in an intake passage of an internal combustion engine. The turbine is configured to be driven by exhaust gas from the internal combustion engine. A part of the exhaust gas is circulated to the intake passage at an upstream side of the compressor.

As in the above configuration (8), in a supercharger provided for an internal combustion engine including an EGR system, intake air containing exhaust air that contains droplets and has a high erosion property is introduced into a compressor of the supercharger.

With the above configuration (8), the supercharger having the above configuration (7) has the above configuration (6) and is provided with a compressor having a high anti-erosion property and anti-crack property (fatigue strength), and thereby it possible to achieve a long-life supercharger that can bear high-speed rotation for a long period of time.

(9) A method of producing an impeller for a rotary machine according to at least one embodiment of the present invention comprises: a step of forming an electroless plating layer as a surface layer of the impeller comprising Al or an Al alloy, so as to cover a base material of the impeller. The electroless plating layer comprises a Ni—P based alloy having an amorphous structure, the Ni—P based alloy having a P content rate of not less than 5 wt % and not more than 11 wt % in the electroless plating layer.

A compressor impeller produced by the above method (9) has the electroless plating layer formed on the surface. The electroless plating layer has an amorphous structure and thus has a high strength and an excellent anti-erosion property. Furthermore, the electroless plating layer contains P of not less than 5 wt % and not more than 11 wt %, thus having a high Vickers hardness and an excellent anti-crack property (fatigue strength).

Moreover, the electroless plating layer can be formed uniformly, for instance, in terms of the layer thickness, and thus it is possible to exert the above properties uniformly over a broad range.

(10) In some embodiments, the above method (9) further comprises a step of cutting out a test piece from the impeller on which the electroless plating layer is formed, and using the test piece to evaluate a fracture ductility of the electroless plating layer. Hardness and ductility of a plating layer changes depending on plating treatment conditions such as the total area of an object to be plated by a plating solution during plating treatment, and the relative velocity between the flow of the plating solution and the object to be plated.

According to the above method (10), the fracture ductility is evaluated by using a test piece cutout from the compressor impeller on which the electroless plating layer is formed, and thus it is possible to accurately evaluate the fracture ductility of the electroless plating layer of the an actual impeller.

(11) In some embodiments, in the above method (10), the test piece is collected from a region on a back surface of the hub of the impeller, the region being a projection of a blade root portion of the hub on the back surface of the hub.

While a stress is generated in an impeller due to a centrifugal force caused by rotation, for instance, the greatest stress is generated at the blade root portion of the impeller, as shown in FIG. 14.

With the above configuration (11), the test piece is collected from a region of a projection of the blade root portion of the hub on the back surface of the hub, and thus it is possible to obtain the fracture ductility under the severest stress conditions.

(12) In some embodiments, the above method (10) or (11) further comprises a step of changing a plating condition of the electroless plating layer if the fracture ductility is smaller than a threshold.

According to the above method (12), the plating conditions of the electroless plating layer are changed on the basis of the result of the fracture ductility, and thus it is possible to set the fracture ductility of the electroless plating layer to be not less than a threshold.

### Advantageous Effects

According to at least one embodiment of the present invention, it is possible to improve both of an anti-erosion property and an anti-crack property (fatigue strength) of an impeller, and thereby extend the lifetime of the impeller and apparatuses including the impeller.

### BRIEF DESCRIPTION OF DRAWINGS

FIG. 1 is a system diagram of a diesel engine provided with a supercharger according to an embodiment.

FIG. 2 is a schematic cross-sectional view of a compressor impeller according to an embodiment.

FIG. 3 is a diagram showing a relationship between the P content rate and the anti-erosion property of an electroless plating layer.

FIG. 4 is a diagram showing a relationship between the P content rate and the LCF fracture lifetime of an electroless plating layer.

FIG. 5 is a diagram of an example of a cyclic load in an LCF test.

FIG. 6 is a diagram showing a relationship between the crystal structure and the anti-erosion property of an electroless plating layer.

FIG. 7 is a diagram showing a relationship between the crystal structure and the LCF fracture lifetime of an electroless plating layer.

FIG. 8 is a diagram showing a relationship between the layer thickness and the anti-erosion property of an electroless plating layer.

FIG. 9 is a diagram showing a result of a corrosion test on an electroless plating layer.

FIG. 10 is a diagram showing the fracture ductility of an electroless plating layer.

FIG. 11 is an explanatory diagram of a method of testing the fracture ductility with a test piece.

FIG. 12 is a flowchart of a method of producing a compressor impeller according to an embodiment.

FIGS. 13A and 13B are diagrams showing a section where a test piece is cut out from a compressor impeller, FIG. 13A showing a side cross-sectional view of a compressor impeller and FIG. 13B showing a front view of the same.

FIG. 14 is a perspective view of a strain distribution which is generated in the compressor impeller.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

FIG. 14 is a diagram of a compressor impeller 100 of a supercharger provided for an automobile internal combustion engine, coated with a typical Ni—P based plating layer, shown with an analysis result of a distribution of strain generated in the compressor impeller projected on a back surface 102a of a hub 102. FIG. 14 shows that the greatest strain, that is, stress, is generated in a region 102b of the hub 102, where the root portions of blades 104 are projected. This stress is mainly generated by a centrifugal force generated when the supercharger rotates at a high speed, and is further combined with a stress due to a thermal expansion difference between the Ni—P based plating layer and a base material comprising an Al alloy, for instance.

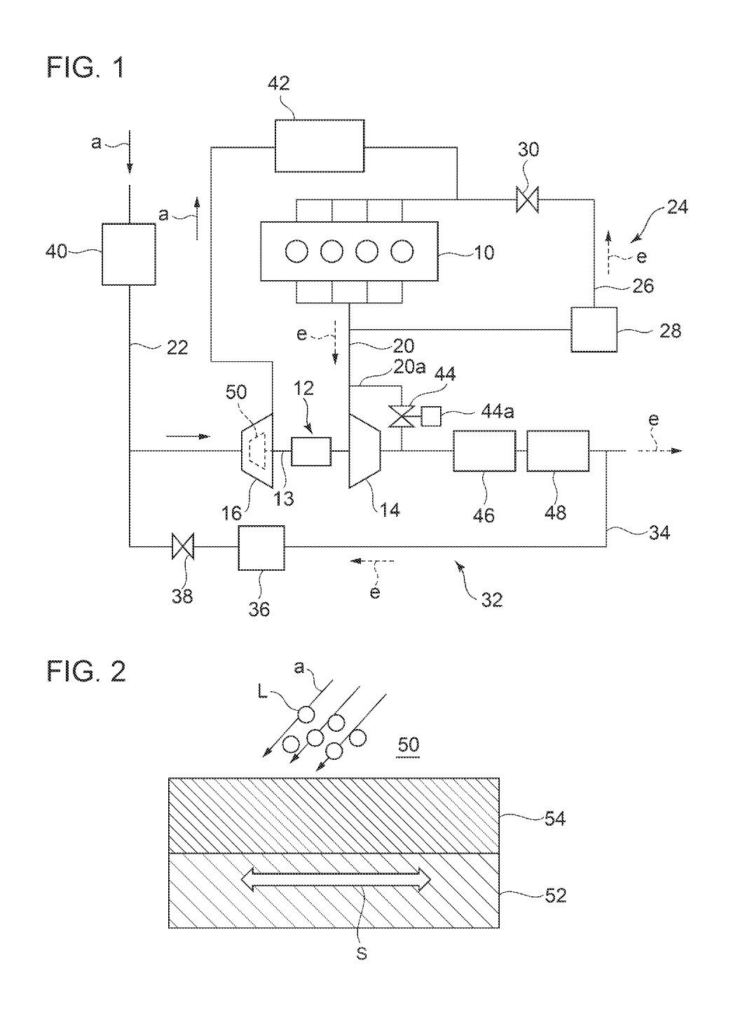

As depicted in FIG. 1, a supercharger 12 according to at least one embodiment of the present invention is provided for an in-vehicle internal combustion engine, for instance, a diesel engine 10 equipped with an EGR system.

The supercharger 12 includes an exhaust turbine 14 which is disposed in an exhaust passage 20 of the diesel engine 10 and which is rotated by exhaust gas “e”, and a compressor 16 which operates in conjunction with the exhaust turbine 14 via a rotational shaft 13. The compressor 16 is disposed in an intake passage 22, and supplies the diesel engine 10 with intake air “a”. A part of exhaust gas is circulated to the intake passage 22 at an upstream side of the compressor 16.

As an exemplary embodiment, as depicted in FIG. 1, a high-pressure EGR system 24 has a high-pressure EGR passage 26 branched from the exhaust passage 20 at the upstream side of the exhaust turbine 14 and connected to the intake passage 22 at the upstream side of the compressor 16.

In the high-pressure EGR system 24, a part of the exhaust gas “e” discharged from the diesel engine 10 is returned to the intake passage 22 at the inlet side of the diesel engine 10 via the high-pressure EGR passage 26.

In an exemplary configuration, an EGR cooler 28 and an EGR valve 30 are disposed in the high-pressure EGR passage 26.

In an exemplary embodiment, a low-pressure EGR system 32 has a low-pressure EGR passage 34 branched from the exhaust passage 20 at the downstream side of the exhaust turbine 14 and connected to the intake passage 22 at the upstream side of the compressor 16.

In the low-pressure EGR system 32, a part of the exhaust gas “e” discharged from the diesel engine 10 is returned to the intake passage 22 at the inlet side of the compressor 16 via the low-pressure EGR passage 34.

In an exemplary configuration, an EGR cooler 36 and an EGR valve 38 are disposed in the low-pressure EGR passage 34.

In an exemplary embodiment, an air cleaner 40 is disposed in the intake passage 22 at the upstream side of the compressor 16, and an inter cooler 42 is disposed in the intake passage 22 at the downstream side of the compressor 16.

Further, an exhaust bypass passage 20a is connected to the exhaust passage 20 so as to bypass the exhaust turbine 14. A waste valve 44 is disposed in the exhaust bypass passage 20a, and an actuator 44a for adjusting the opening degree of the waste valve 44 is provided.

Further, a DPF filter 48 for capturing particulate matter in the exhaust gas, and an oxidation catalyst 46 for oxidizing NOx in the exhaust gas to NO₂ and combusting the particulate matter captured by the DPF filter 48 by oxidation of NO₂ are disposed in the exhaust passage 20 at the downstream side of the exhaust turbine 14.

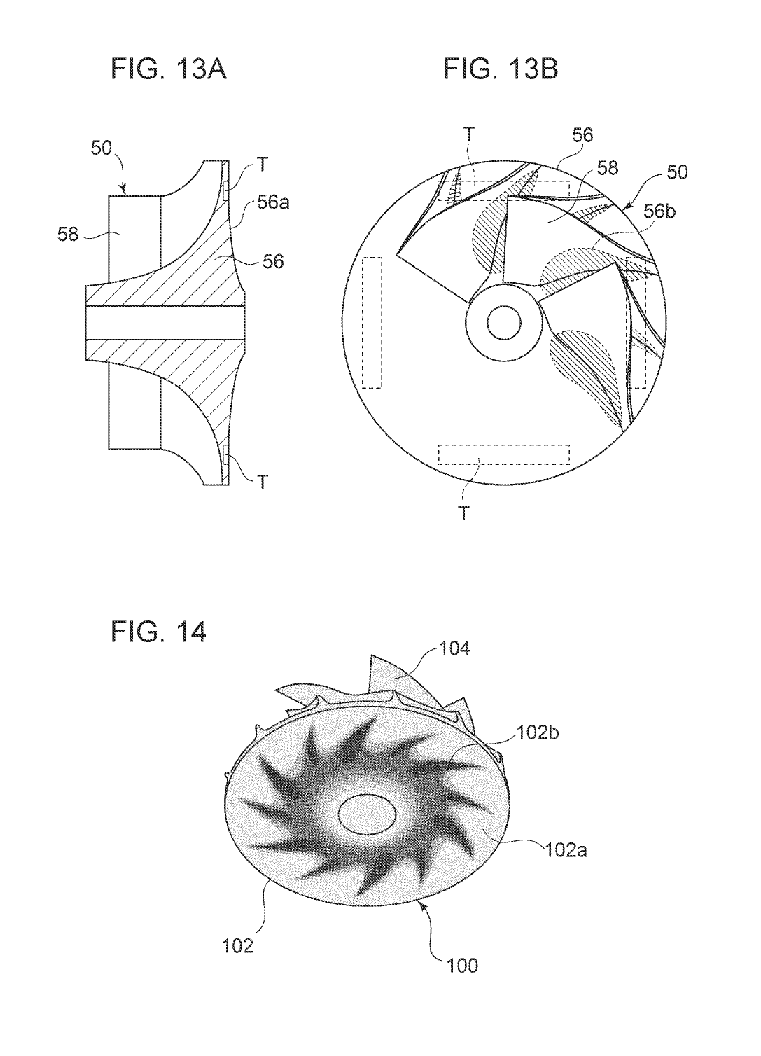

A compressor according to at least one embodiment of the present invention is the compressor 16 provided for the supercharger 12 depicted in FIG. 1. The compressor 16 includes a compressor impeller 50 disposed on an end of the rotational shaft 13 inside a compressor housing (not depicted). The compressor impeller 50 has, for instance, a configuration as depicted in FIG. 13.

As schematically shown in FIG. 2, the compressor impeller 50 includes a base material 52 comprising Al or an Al alloy and an electroless plating layer 54 formed on the surface of the base material 52. The electroless plating layer 54 comprises a Ni—P based alloy having an amorphous structure and containing P of not less than 5 wt % and not more than 11 wt % in the layer.

The electroless plating layer 54 has an amorphous structure and thus has a high strength, thus being able to exert a high anti-erosion property. Furthermore, the electroless plating layer 54 contains P of not less than 5 wt % and not more than 11 wt %, which makes it possible to achieve an excellent anti-crack property (fatigue strength) while having a high Vickers hardness. Accordingly, it is possible to achieve both of the anti-erosion property and the anti-crack property.

Moreover, the electroless plating layer 54 is an electroless plating layer and thus can be formed uniformly, for instance, in terms of the layer thickness, and thus it is possible to exert the above two properties uniformly over a broad range.

As depicted in FIG. 2, the intake air “a” may contain a foreign substance such as a droplet L. For instance, if the low-pressure EGR system 32 depicted in FIG. 1 is employed, the exhaust gas “e” containing a water droplet L is circulated via the low-pressure EGR passage 34 and is supplied to the compressor with the intake gas a. As described above, even if the intake air “a” contains a foreign substance (e.g. droplet L), the electroless plating layer 54 has a good anti-erosion property and a good anti-crack property, thus being resistant to erosion by the exhaust gas “e” and being capable of suppressing generation of cracks.

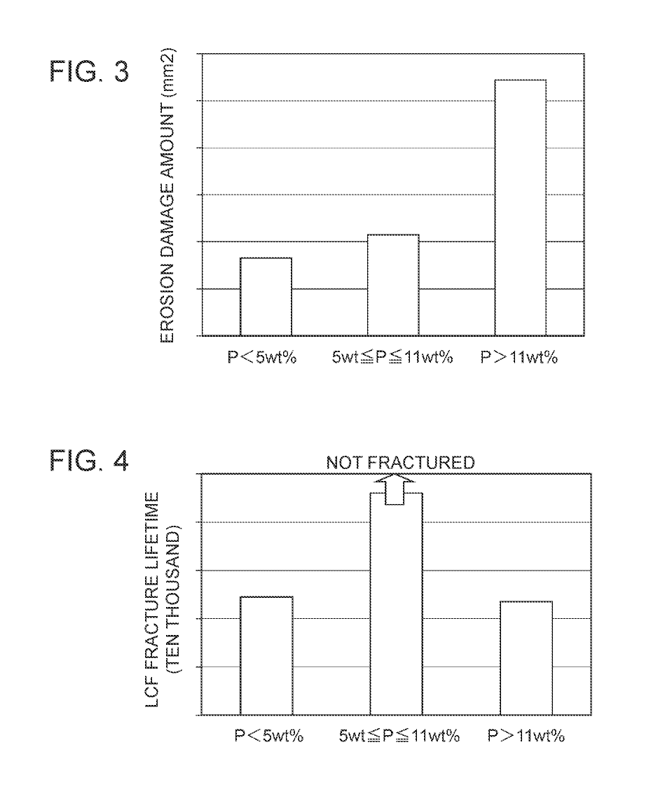

FIG. 3 is a test result showing a relationship between the P content rate and the anti-erosion property of the electroless plating layer 54. FIG. 4 is a test result showing a relationship between the P content rate and the low-cycle fatigue (LCF) test fracture lifetime of the electroless plating layer 54. The low-cycle fatigue (LCF) is a fatigue fracture that develops on a member when such a great cyclic load that causes plastic deformation is applied to the member.

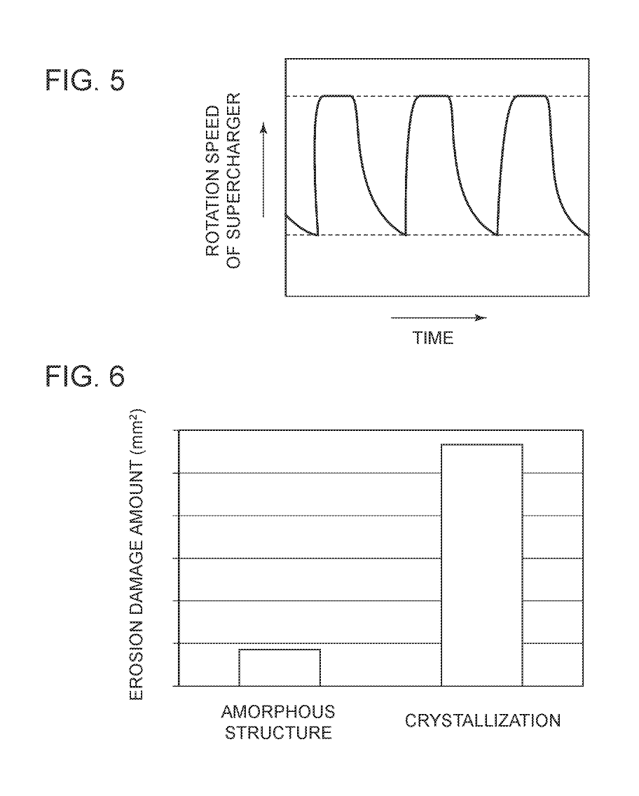

FIG. 5 is a diagram of an example of a cyclic load applied to a compressor impeller in an LCF test, where x-axis is time and y-axis is rotation speed of a supercharger equipped with the compressor impeller. A change in the rotation speed of the supercharger changes the cyclic load applied to the electroless plating layer 54.

As depicted in FIGS. 3 and 4, the anti-erosion property rapidly decreases when the P content rate exceeds 11 wt %, while the LCF fracture lifetime decreases when the P content rate is less than 5 wt % or more than 11 wt %.

From the above result, the electroless plating layer 54 contains P of not less than 5 wt % and not more than 11 wt % to balance the anti-erosion property and the LCF fracture lifetime.

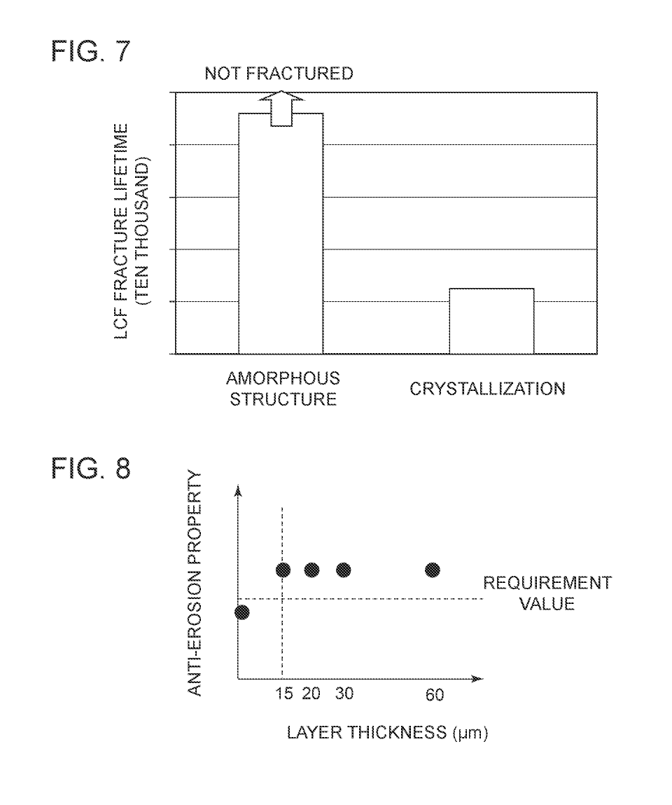

FIG. 6 is a test result showing a relationship between different crystal structures and the anti-erosion property of the electroless plating layer 54. FIG. 7 is a test result showing a relationship between different crystal structures and the LCF fracture lifetime of the electroless plating layer 54. The “crystallization” in the drawings means that the electroless plating layer 54 having an amorphous structure is crystallized by heat treatment or the like.

As depicted in FIGS. 6 and 7, when the electroless plating layer 54 is crystallized, the anti-erosion property and the LCF fracture lifetime deteriorate rapidly.

From the above result, the electroless plating layer 54 is formed so as to have an amorphous structure to improve the anti-erosion property and the LCF fracture lifetime.

In an illustrative embodiment, the electroless plating layer 54 has a layer thickness of not less than 15 μm and not more than 60 μm. If the layer thickness of the electroless plating layer 54 is less than 15 μm, it may be difficult to exert the anti-erosion property and the anti-crack property sufficiently. On the other hand, even if the layer thickness is increased to exceed 60 μm, the effect to improve the anti-erosion property and the anti-crack property is limited, which rather increases the plating time and costs.

Accordingly, it is possible to achieve both of the anti-erosion property and the anti-crack property when the electroless plating layer 54 has a layer thickness of not less than 15 μm, and it is possible to reduce the plating costs when the electroless plating layer 54 has a layer thickness of not more than 60 μm.

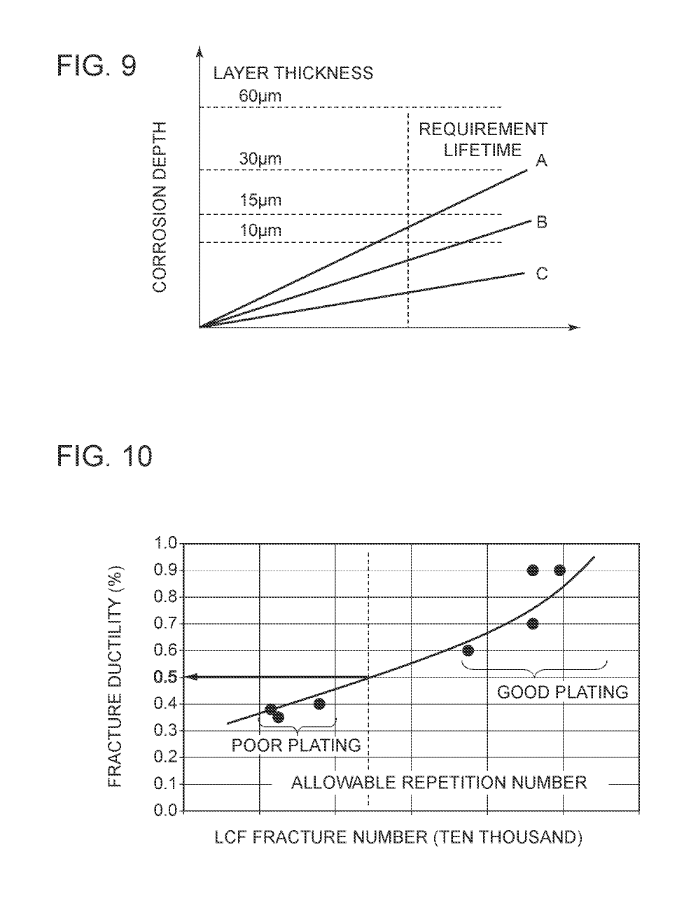

FIG. 8 is a test result showing a relationship between the layer thickness and the anti-erosion property of the electroless plating layer 54. FIG. 9 is a test result showing a relationship between the layer thickness and the anti-corrosion property of the electroless plating layer 54.

As depicted in FIG. 8, the electroless plating layer 54 cannot exert the anti-erosion property when having a layer thickness of about 1 to 2 μm, but can exert a high anti-erosion property when the layer thickness is in the range of from 15 to 60 μm. The lines A, B, and C in FIG. 9 show the progress of corrosion on the electroless plating layer 54 for different corrosion environments. FIG. 9 shows that the requirement lifetime can be satisfied when the electroless plating layer 54 has a layer thickness of not less than 15 μm, even in the severest corrosion environment.

In an illustrative embodiment, the electroless plating layer 54 has a Vickers hardness of not less than 500 HV and not more than 700 HV. In this case, the electroless plating layer 54 has a Vickers hardness of not less than 500 HV and thus can exert an anti-erosion property, while having a Vickers hardness of not more than 700 HV and thus being able to exert a high anti-crack property.

In an illustrative embodiment, as depicted in FIG. 10, if the fracture ductility strain of the electroless plating layer 54 having the above configuration is not less than 0.5%, the fracture lifetime in a LCF fracture test clears an allowable repetition number and a crack does not occur.

Accordingly, the electroless plating layer 54 having the above configuration is a plating layer with a high anti-fatigue fracture property, thus being capable of suppressing generation of cracks of an impeller and of improving the lifetime of an impeller.

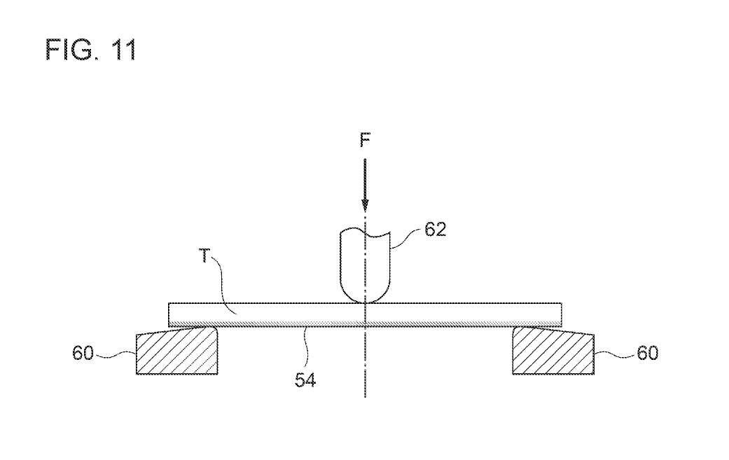

The fracture ductility is measured by a test as depicted in FIG. 11, for instance. In FIG. 11, both ends of a test piece T having a plate shape with a rectangular cross section are placed on support bases 60 so that a side on which the electroless plating layer 54 is formed faces down. Subsequently, a load F is applied downward by placing an indenter 62 on an upper surface of the test piece T at the center in the axial direction to generate a predetermined strain. The above operation is repeated while changing the load until the plating layer fractures.

The compressor impeller 50 having the above configuration is used as the compressor impeller of the supercharger 12 that rotates at a high speed, and thereby it is possible to improve the anti-erosion property of the compressor impeller 50 and to restrict development of cracks, thus improving the lifetime of the compressor 16 and the supercharger 12 provided with the compressor 16.

Furthermore, even if the supercharger 12 is provided for the diesel engine 10 having the low-pressure EGR system 32 and the intake air “a” that contains exhaust gas containing droplets and having a high erosive property is introduced into the compressor 16, the supercharger 12 can endure high-speed rotation for a long time and the lifetime can be improved.

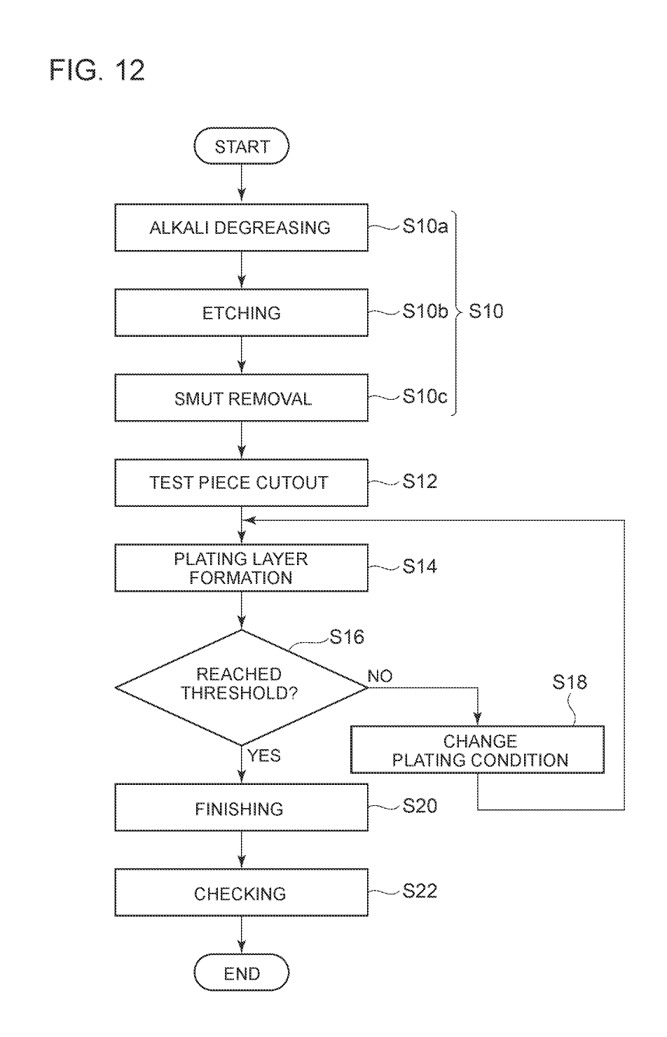

A method of producing an impeller for a rotary machine according to at least one embodiment of the present invention comprises a step (S14) of forming the electroless plating layer 54 on a surface of the compressor impeller 50 formed of Al or an Al alloy, so as to cover the compressor impeller 50, as depicted in FIG. 12.

The electroless plating layer 54 comprises a Ni—P based alloy having an amorphous structure and containing P of not less than 5 wt % and not more than 11 wt % in the electroless plating layer 54.

The compressor impeller 50 produced by the above method has the electroless plating layer 54 formed on the surface. The electroless plating layer 54 has an amorphous structure and thus has a high strength, thereby achieving an excellent anti-erosion property. Furthermore, the electroless plating layer contains P of not less than 5 wt % and not more than 11 wt %, thus having a high Vickers hardness and an excellent anti-crack property (fatigue strength).

Moreover, the electroless plating layer 54 can be formed uniformly, for instance, in terms of the layer thickness, and thus it is possible to exert a high anti-erosion property and a high anti-crack property (fatigue strength) uniformly over the entire range of the plating layer.

In an illustrative embodiment, as depicted in FIG. 12, prior to step S14, the method further comprises a step S12 of cutting out a test piece from the compressor impeller 50 having the electroless plating layer 54 formed thereon, and using the test piece to evaluate the fracture ductility of the electroless plating layer 54.

In other words, as depicted in FIG. 13, the test piece T is cut out from the compressor impeller 50 to be used to evaluate the fracture ductility.

Hardness and ductility of a plating layer changes depending on plating treatment conditions such as the total area of an object to be plated by a plating solution during plating treatment, and the relative velocity between the flow of the plating solution and the object to be plated.

Since the fracture ductility is evaluated by using the test piece T cutout from the compressor impeller 50 on which the electroless plating layer 54 is formed, it is possible to accurately obtain the fracture ductility of the electroless plating layer 54 of the actually-produced compressor impeller 50.

In an illustrative embodiment, as depicted in FIG. 13, the test piece T is collected from a region 56b on a back surface 56a of a hub 56 of the compressor impeller 50, the region 56b being projection of a blade root portion of the hub 56 on the back surface 56a of the hub 56.

While a stress is generated in the compressor impeller 50 due to a centrifugal force caused by rotation, for instance, the greatest stress is generated at the blade root portion of the hub 56, as shown in FIG. 14.

By collecting the test piece T from the region 56b, it is possible to obtain the fracture ductility under the severest stress condition.

In an illustrative embodiment, as depicted in FIG. 12, if the measured fracture ductility is less than a threshold (S16), the method further comprises a step S18 of changing plating conditions for forming the electroless plating layer 54 (e.g. relative velocity between the flow of the plating solution and the object to be plated, plating time, etc.)

Accordingly, the plating conditions of the electroless plating layer 54 are changed on the basis of the result of the fracture ductility, and thus it is possible to set the fracture ductility of the electroless plating layer 54 to be not less than a threshold.

In an illustrative embodiment, as depicted in FIG. 12, a pretreatment S10 is performed on the test piece T that is cut out prior to step S12, as shown in FIG. 12.

The pretreatment S10 includes: an alkali degreasing step S10a of removing grease or the like adhering to the surface of the test piece T with an alkali solution or the like; an etching treatment step S10b of removing a passive state layer (alumina layer) formed on the surface of the degreased test piece T by using an acid solution or an alkali solution; and a smut removing step S10c of removing smut which is C and Si less soluble to acid or the like remaining in the form of black powder after the etching treatment.

In a plating layer forming step S14, as an illustrative embodiment, the surface of the test piece T is plated with Zn, and then Zn is replaced with a Ni—P based alloy, thereby forming the electroless plating layer 54.

In an illustrative embodiment, after the plating layer forming step S14, performed are a step S20 of finishing the surface of the test piece T and a check step S22 of checking the finished test piece T.

### INDUSTRIAL APPLICABILITY

According to at least one embodiment of the present invention, it is possible to form an electroless plating layer on an impeller for a rotary machine, whereby it is possible to achieve both of a good anti-erosion property and a good anti-crack property (fatigue strength), and thereby improve the lifetime of the impeller and apparatuses including the impeller.

### DESCRIPTION OF REFERENCE NUMERALS

10 Diesel engine
12 Supercharger
13 Rotational shaft
14 Exhaust turbine
16 Compressor
20 Exhaust passage
22 Intake passage
24 High-pressure EGR system
26 High-pressure EGR passage
28, 36 EGR cooler
30, 38 EGR valve
32 Low-pressure EGR system
34 Low-pressure EGR passage
40 Air cleaner
42 Inter cooler
44 Waste valve
44a Actuator
46 Oxidation catalyst
48 DPF filter
50, 100 Compressor impeller
52 Base material
54 Electroless plating layer
56, 102 Hub
56a, 102a Back surface
58, 104 Blade
60 Support base
62 Indenter
C Crack
S Strain
a Intake air
e Exhaust gas

1. An impeller for a rotary machine, comprising:
a base material of the impeller comprising Al or an Al alloy; and
an electroless plating layer disposed so as to cover the base material, the electroless plating layer forming a surface layer of the impeller,
wherein the electroless plating layer comprises a Ni—P based alloy having an amorphous structure, the Ni—P based alloy having a P content rate of not less than 5 wt % and not more than 11 wt % in the electroless plating layer.

2. The impeller for a rotary machine according to claim 1,
wherein the electroless plating layer has a layer thickness of not less than 15 μm and not more than 60 μm.

3. The impeller for a rotary machine according to claim 1,
wherein the electroless plating layer has a Vickers hardness of not less than 500 HV and not more than 700 HV.

4. The impeller for a rotary machine according to claim 1,
wherein a fracture ductility strain of the electroless plating layer is not less than 0.5%.

5. The impeller for a rotary machine according to claim 1,
wherein the impeller is a compressor impeller of a supercharger.

6. A compressor comprising a compressor impeller which comprises the impeller according to claim 1.

7. A supercharger, comprising:
the compressor according to claim 6; and
a turbine for driving the compressor.

8. The supercharger according to claim 7,
wherein the compressor is disposed in an intake passage of an internal combustion engine,
wherein the turbine is configured to be driven by exhaust gas from the internal combustion engine, and
wherein a part of the exhaust gas is circulated to the intake passage at an upstream side of the compressor.

9. A method of producing an impeller for a rotary machine, comprising:
a step of forming an electroless plating layer as a surface layer of the impeller comprising Al or an Al alloy, so as to cover a base material of the impeller,
wherein the electroless plating layer comprises a Ni—P based alloy having an amorphous structure, the Ni—P based alloy having a P content rate of not less than 5 wt % and not more than 11 wt % in the electroless plating layer.

10. The method of producing an impeller for a rotary machine according to claim 9, further comprising a step of cutting out a test piece from the impeller on which the electroless plating layer is formed, and using the test piece to evaluate a fracture ductility of the electroless plating layer.

11. The method of producing an impeller for a rotary machine according to claim 10, wherein the test piece is collected from a region on a back surface of the hub of the impeller, the region being a projection of a blade root portion of the hub on the back surface of the hub.

12. The method of producing an impeller for a rotary machine according to claim 10, further comprising a step of changing a plating condition of the electroless plating layer if the fracture ductility is smaller than a threshold.
